(19) United States
(12) Patent Application Publication
(10) Pub. No.: US 2013/0319942 A1
(43) Pub. Date: Dec. 5, 2013

(54) FLUORINE TREATMENT OF DIFFUSER MEMBRANES USED IN WASTEWATER AERATION

(71) Applicants: Charles E. Tharp, Columbia, MO (US); Randall C. Chann, Columbia, MO (US); Warrick S. Wadman, Columbia, MO (US); David A. Capron, Columbia, MO (US)

(72) Inventors: Charles E. Tharp, Columbia, MO (US); Randall C. Chann, Columbia, MO (US); Warrick S. Wadman, Columbia, MO (US); David A. Capron, Columbia, MO (US)

(21) Appl. No.: 13/482,437

(22) Filed: May 29, 2012

(51) Int. Cl. B01D 63/00; B05D 1/36; B05D 3/00; B01D 61/00

(52) U.S. Cl. 210/639; 210/209; 427/248.1

(57) ABSTRACT

A flexible diffuser membrane used in aeration/mixing of wastewater is impregnated with biocide and treated with fluorine or another halogen gas which forms a barrier inhibiting migration of the biocide out of the membrane. Another aspect of the invention involves cleaning a diffuser membrane with a halogen and then coating the membrane with PTFE or polyurethane.

### CROSS-REFERENCE TO RELATED APPLICATIONS

None.

### FIELD OF THE INVENTION

This invention relates generally to the field of wastewater aeration/mixing and more particularly to a diffuser membrane which is treated with fluorine in a manner to enhance its ability to effectively aerate wastewater.

### BACKGROUND OF THE INVENTION

Flexible membrane diffusers have long been used in the aeration of wastewater and are often used with tubular and disc type diffusers. Exemplary of a tubular membrane diffuser is U.S. Pat. No. 4,960,546 to Tharp.

Flexible membrane diffusers are conventionally constructed of rubber or a similar material which is punctured to provide a large number of perforations. When air is applied to the diffuser, the air pressure expands the membrane away from the diffuser body and causes the perforations to open so that the air discharges through them in the form of fine bubbles. It is important for the bubble size to be minimized because finer bubbles transfer air to the wastewater more efficiently. When the air pressure is relieved, the membrane collapses on the diffuser body to close the perforations and prevent the wastewater from entering the diffuser.

Although flexible membrane diffusers are advantageous in many respects and have achieved widespread acceptance in a variety of gas diffusion applications, they are not wholly free of problems. Rubber or synthetic rubber is typically used to construct the membrane. In a wastewater treatment application and in other applications, materials in the liquid can become deposited on and build up on the membrane to clog or partially clog the perforations and thus reduce the efficiency of the diffuser. For example, fats, grease and other substances which are commonly found in wastewater can adhere to the membrane. Calcium and calcium compounds such as calcium carbonate and calcium sulfate as well as other substances are especially problematic when they precipitate and build up on the diffuser membrane. Biological growth can also build up and compromise the diffuser efficiency.

Diffuser membranes can also be chemically degraded by solvents and various other types of chemicals that may be present in the liquid. This chemical degradation combined with the repeated expansion and contraction of the membrane can weaken the membrane and cause premature structural failure. Another problem is that beneficial oils in the membrane can leach out over time, which can result in a loss of elasticity and flexibility and an increase in brittleness.

U.S. Pat. No. 6,543,753 to Tharp discloses the treatment of diffuser membranes with biocide in order to inhibit biological growth on the membrane. Although the biocide is effective, it can leach out of the membrane over time and lose its effectiveness.

U.S. Pat. No. 7,815,974 to Charles E. Tharp discloses a technique for applying a fluorocarbon elastomer coating to a membrane in order to resist chemical and biological attack. Although this technique is generally effective, it is not wholly satisfactory in all respects. It requires heating of the substrate and coating and thus involves added energy consumption in the manufacturing process. Also, the coating is not always bonded effectively at all locations and can wear off and/or degrade. While this process envisions cleaning of the membrane prior to coating in order to enhance the bond of the coating, the solvents and other cleaners that are used for cleaning are not always effective. Any impurities or contaminants that are present inhibit the formation of an effective bonding of the coating and result in a final product that is less than ideal.

### SUMMARY OF THE INVENTION

The present invention is directed to an improved flexible diffuser membrane and to an improved method of constructing a flexible membrane which enhances the ability of the membrane to withstand chemical, biological and physical attack.

In accordance with one aspect of the invention, a flexible diffuser membrane is supplied with a biocide to inhibit biological attack and is treated with a halogen gas, preferably fluorine, which is securely bonded to at least the surface area of the membrane to provide a barrier that impedes migration of the biocide out of the membrane. A substrate formed of a flexible material such as EPDM, NBR, a blend based compound, a fabric material or another substance is first constructed and impregnated with a biocide. The resulting membrane structure is then subjected to treatment with fluorine or another halogen gas under vacuum conditions such that the halogen bonds to the surface of the membrane and may penetrate the surface to form a securely bonded barrier which confines the biocide in the membrane and prevents it from leaching out in significant quantities.

This membrane structure and the manner of constructing it provide numerous benefits. First, the substrate is able to resist biological growth due to the presence of the biocide while exhibiting optimum physical characteristics such as structural integrity, flexibility and other beneficial attributes. The halogen barrier can have whatever thickness is desired and can be applied to both the inside and outside surfaces of the membrane. The edges of the perforations that are created when the membrane is perforated can receive the halogen treatment to provide protection of these edges, or the edges can remain untreated so that the biocide can remain active there to prevent biofouling.

The result is a flexible membrane that takes advantage of the structural integrity and flexibility of the substrate while being treated with biocide which is confined by the halogen barrier. At the same time, the halogen barrier retains beneficial oils in the membrane to allow it to remain elastic and flexible while inhibiting physical attack and attack by chemicals and other contaminants in the wastewater.

Another aspect of the invention involves halogen treatment applied to a diffuser membrane for effective cleaning of the membrane prior to the application of a polytetrafluoroethylene (PTFE) or polyurethane coating to enhance the bond of the coating to the membrane substrate. It has been found that halogens, and especially fluorine, are highly effective as cleaning agents to remove any foreign materials that may be present on the membrane substrate, and the removal of foreign materials results in the formation of a much better bond between the PTFE or polyurethane coating and the membrane substrate.

### BRIEF DESCRIPTION OF THE SEVERAL VIEWS OF THE DRAWINGS

In the accompanying drawings:

FIG. 1 is a fragmentary perspective view of a portion of an aeration system for aerating wastewater that is equipped with a tubular diffuser having a flexible membrane constructed according to a preferred embodiment of the present invention;

FIG. 2 is a fragmentary enlarged view of one of the membrane perforations identified in FIG. 1 by detail 2;

FIG. 3 is a sectional view of the membrane on an enlarged scale taken generally along line 3-3 of FIG. 1 in the direction of the arrows, with the thicknesses of the exterior and interior barriers exaggerated for purposes of illustration; and

FIG. 4 is a sectional view on an enlarged scale similar to FIG. 3, but showing coatings applied to the membrane in accordance with another embodiment of the invention.

### DETAILED DESCRIPTION OF THE PREFERRED EMBODIMENT

The present invention is directed to a flexible diffuser membrane and to a process of constructing the membrane. Membranes of this type are used in wastewater treatment systems in which flexible membrane diffusers are commonly used to diffuse air into the wastewater for aeration and mixing purposes. Flexible membrane diffusers are used in this type of application both on tubular diffusers and disc diffusers.

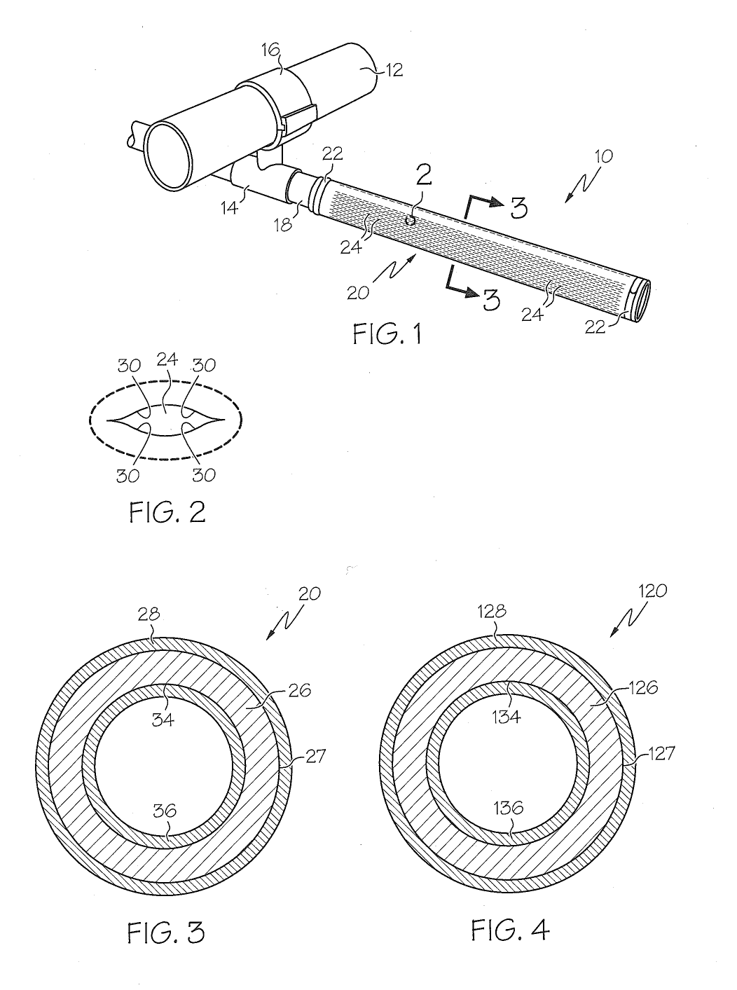

While FIG. 1 depicts a tubular membrane diffuser generally identified by numeral 10, it is to be understood that the invention is equally applicable to membranes for disc diffusers and other types of diffusers that are used in wastewater treatment.

The diffuser 10 is used in an aeration system which includes a variety of air lateral pipes such as the pipe 12 which may be floating on the surface of the liquid or submerged. Air is supplied to the pipe 12 from a blower or other air source (not shown) and is discharged into a tee-fitting 14 connected with a saddle structure 16 used to mount the diffuser assembly on the pipe 12. FIG. 1 depicts tubular diffusers extending from each of the side outlets of the tee-fitting 14 (one shown only fragmentarily), although other arrangements are possible. Diffuser systems and structures different from what is shown in FIG. 1 are within the scope of the invention.

The diffuser 10 includes a hollow rigid diffuser body 18 which is connected with an outlet of the tee-fitting 14 and extends generally horizontally. The diffuser body 18 is provided with one or more openings (not shown) which discharge the gas within a flexible membrane 20 sleeved onto and secured to the diffuser body 18 by band clamps 22 or other suitable fasteners. The membrane 20 is provided with a plurality of small perforations 24 which may take the form of slits arranged in any desired pattern.

When air is applied to the diffuser body 18 from the lateral pipe 12, the gas pressure causes the membrane 20 to expand from the diffuser body 18, thus opening the perforations 24 and discharging the gas through the perforations into the liquid in the form of fine bubbles which are beneficial in that they efficiently transfer the gas to the liquid. When the gas pressure is relieved, the flexible membrane 20 collapses back onto the diffuser body 18 and thus closes the perforations 24 so that the liquid is unable to leak into the diffuser.

The present invention is directed to the treatment of the membrane 20 to enhance its effectiveness and reliability. As best shown in FIG. 3, the membrane 20 includes a substrate 26 having, in this example, a tubular shape. The substrate 26 may be constructed of any suitable material that exhibits the necessary structural properties and flexibility. Examples of materials that are suitable for the substrate 26 are elastomer based rubber compounds such as EPDM, nitrile rubber, NR, or various fabrics and other polymers, as well as other substances having the necessary qualities.

The membrane 20 is constructed by first manufacturing and fully curing the substrate 26. After the substrate 26 has been constructed, its surface (inside and outside surfaces if desired) may be cleaned with solvents or other materials using various types of cleaning techniques to eliminate any foreign materials that may be present on the substrate.

In accordance with one aspect of the present invention, the structural components of the substrate 26 may be mixed with a biocide that, due to the mixing process, is dispersed throughout the wall of substrate 26 in a relatively uniform manner. The biocide is preferably carbolic acid or phenol. By way of example, the biocide may be a compound that is commercially available from Clariant Corporation of Charlotte, N.C. under the trademark NIPACIDE which is an antimicrobial agent. Other suitable biocidal agents are also contemplated.

By mixing the biocide with the other components of the membrane, the biocide is dispersed throughout the EPDM rubber matrix. The EPDM rubber (or other material in which the biocide is dispersed) is preferably molded or otherwise suitably formed into the shape desired for the membrane 20. The membrane material is impervious to liquid.

Either before or after the biocide has been applied to the membrane 20, preferably by dispersing it throughout the membrane, and the membrane has been molded or otherwise formed, the aeration slits 24 are formed through the membrane wall. The slits 24 serve as controlled aeration apertures which are closed when the membrane 20 is sealed against the outer surface of the diffuser body 18 in the absence of air pressure. However, when air is supplied to the interior of the membrane, the membrane 20 expands outwardly away from the diffuser body, as permitted by its flexibility. Then, the aeration slits 24 open and allow the air to pass through them and discharge into the wastewater in the form of fine bubbles resulting from the small size of the slits 24. When the aeration system is deactivated and the air pressure is withdrawn, the elasticity of the membrane 20 causes it to collapse again tightly on the diffuser body 18, thereby again closing the slits 24 and sealing the diffuser against the outside surface of the diffuser body. Consequently, the wastewater is unable to enter the diffuser body and the distribution piping of the aeration system because the slits 24 do not provide access for the wastewater and the membrane 20 is impervious to liquid.

The treatment of the membrane 22 with biocide inhibits the growth and buildup of algae and other biological material on the membrane surface. A membrane that is not treated with biocide can be subject to accumulation of biological growth which traps the fine bubbles discharged through the slits 24 and causes them to merge and form larger bubbles before they are released from the biological growth into the wastewater. Large bubbles result in less efficient aeration because the bubble volume to surface area ratio is larger with larger bubbles, and the oxygen transfer to the wastewater suffers accordingly. Thus, by using the biocidally treated membrane 20 of the present invention, the efficiency of the oxygen transfer remains intact because the growth and buildup of biological materials is inhibited by the biocide.

The present invention contemplates biocidally treated membranes having configurations other than the tubular or cylindrical configuration of the membrane 20. By way of example, disk type diffusers having a diffuser body presenting a plenum that is covered by a disk-shaped membrane can make use of a biocidally treated membrane in accordance with the present invention. With this type of diffuser, the membrane collapses to a flat condition covering the plenum in the absence of air pressure, with the aeration slits closing to prevent seepage of wastewater into the plenum and the aeration piping of the system. When air pressure is applied, the air flows to the plenum and causes the membrane to expand or bulge outwardly, thereby opening the aeration slits and allowing air to discharge into the wastewater in the form of fine bubbles which are efficient for the aeration and mixing function of the aeration system. The effect of the biocidal agent in connection with a membrane of a disk type diffuser is substantially the same as in the case with a tubular membrane such as membrane 20. References to elasticity herein means the tendency of the material to revert to its original shape after having been deformed.

After the biocide has been applied to the membrane substrate 26, the membrane may be subjected to halogen gas treatment in a manner to bond the halogen to at least an outside surface 27 of the substrate. The halogen gas is preferably fluorine gas. The fluorine gas or other halogen may be applied by exposing the substrate 26 to the halogen gas under vacuum conditions (such as in a vacuum chamber) at an elevated temperature which may be about 100° F., for example. The halogen ions react with the polymer chain of which membrane 26 is constructed in a manner to replace hydrogen atoms with halogen. Fluorine and other halogens are strong oxidizing agents which are able to form strong bonds with carbon.

In this manner, a coating 28 of halogen is applied to at least the surface 27 of the substrate 26 to provide a barrier that prevents or at least inhibits migration of the biocide out of the surface 27. The thickness of the coating 28 (its penetration into surface 27) can be controlled as desired by controlling the exposure of the halogen to the substrate. Coatings of 2.3 Angstroms can be achieved and are adequate to inhibit significant migration of the biocide out of the substrate 26 under normal service of the membrane 20.

The substrate 26 may be treated with halogen before or after the perforations 24 are formed through the substrate by conventional techniques. As best shown in FIG. 2, each of the perforations 24 presents edges 30. It may be desirable in some applications to form the perforations 24 after the halogen treatment because the perforation edges 30 are then fully exposed and maintained as the hydrophilic material of the substrate 26. As a result of this hydrophilic quality of the edges 30, the bubbles that are released from the membrane 20 into the liquid are extremely fine bubbles which are efficient in transferring gas to the liquid and thus enhance the overall efficiency of the gas diffusion process. Also, the biocide concentrates at the edges 30 to inhibit biological fouling where the air bubbles are released. On the other hand, the halogen treatment may be carried out after the perforations 24 are formed so that the edges 30 are penetrated by the halogen to inhibit biocide migration out through the edges.

The substrate 26 has an inside surface 34 which may be provided with a coating 36 as a result of the halogen treatment. The inside coating 36 provides the same function as coating 28.

In addition to preventing migration of the biocide out of the membrane, the coatings 28 and 36 (if provided) prevent contaminants in the liquid from becoming deposited on and accumulating on the membrane 20, as the coating 26 presents a slick surface that resists adhesion of the foreign materials. The coatings 28 and 36 are also beneficial in that they resist the growth of biological materials that could otherwise build up on the substrate 26. The coatings 28 and 36 are also resistant to chemicals and other solvents that can chemically attack and degrade or destroy the substrate 26. At the same time, beneficial oils in membrane 20 that maintain its flexibility and elasticity are prevented by the coatings 28 and 36 from leaching out of the membrane.

Another aspect of the invention involves the use of fluorine or another halogen as a cleaning agent to thoroughly and effectively clean fully cured membranes which can then be coated with PTFE or polyurethane, which can be strongly bonded to the membrane and to the removal of contaminants and foreign materials as a result of the halogen cleaning. In accordance with this aspect of the invention, and as shown in FIG. 4, a flexible diffuser membrane 120 is constructed by fully curing a tubular membrane substrate 126 which may be identical to substrate 26. Fluorine or another halogen is then applied to at least an outer surface 127 of the substrate 126 to serve as a cleaning agent which effectively and thoroughly removes foreign materials from the surface of the substrate. The fluorine or other halogen may be applied in the manner previously set forth for substrate 26, in which case the halogen may penetrate into the substrate wall, or in any other suitable manner. Substrate 126 has an inside surface 134 which may optionally be cleaned in the same manner.

After the substrate 126 has been cleaned adequately, a polytetrafluoroethylene (PTFE) or polyurethane coating 128 may be applied. The coating 128 may be mixed with a suitable adhesive catalyst that may be any suitable type selected to affect a strong bond with the substrate 126. After the coating 128 and the catalyst have been mixed, they may be applied to the surface of the substrate 126 in any suitable manner, including application by spraying, brushing, rolling, electrostatic application or another technique. After the coating 128 has been applied to the desired thickness, the substrate 126 and coating 128 are together heated to an elevated temperature selected to achieve sintering or bonding of the coating to the substrate creating maximum cross-linking, chemical bonding, molecular bonding and adhesive bonding of the coating 128 to the substrate 126. Depending upon the materials, the temperature to which the substrate and coating is heated to obtain maximum bonding may be in the range of about 350° F. to about 800° F. Preferably, the substrate 126 and coating 128 are heated together to a temperature between approximately 600° F. and 700° F. for most suitable materials. The sintering or cross-linking and chemical, molecular or adhesive bonding effected by heating to these temperature ranges, together with the presence of the adhesive catalyst, creates a bond between the coating 128 and substrate 126 which is able to withstand the forces applied to the membrane 20 in normal service. The bond is further enhanced by the removal of foreign materials from the substrate by the halogen cleaning process.

The substrate 126 has an inside surface 34 which may optionally be provided with a coating 136. After being cleaned using halogen as previously described, the inside coating 136 is applied in a similar manner as the coating 128 and acts to protect the inside substrate surface 134.

The coatings 128 and 136 (if provided) prevent contaminants in the liquid from becoming deposited on and accumulating on the membrane 120, as the coating 126 presents a slick or nonstick surface that resists adhesion of the foreign materials. The coatings 128 and 136 are also beneficial in that they resist the growth of biological materials that could otherwise build up on the substrate 126. The coatings 128 and 136 are also resistant to chemicals and other solvents that can chemically attack and degrade or destroy the substrate 126.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A method of constructing a flexible diffuser membrane used on a diffuser body to aerate wastewater, said method comprising:
providing a membrane substrate constructed of a flexible elastic material and having a wall presenting a wall surface exposed to wastewater in service of the membrane;
dispersing a biocide throughout said wall of the substrate; and
applying a halogen gas to said substrate in a manner to bond the halogen to at least said wall surface to form a barrier thereon resisting migration of the biocide out of said wall through said wall surface.

2. A method as set forth in claim 1, including the step of perforating said wall to provide perforations through which air can pass for aeration of the wastewater, said steps of dispersing a biocide and applying a halogen gas both being carried out prior to said perforating step.

3. A method as set forth in claim 1, including the step of providing perforations through said wall for the passage of air after said step of dispersing a biocide and before said step of applying a halogen gas.

4. A method as set forth in claim 1, wherein said halogen gas comprises fluorine gas.

5. A diffuser membrane applicable to a diffuser body for aeration of wastewater in which the membrane and diffuser body are immersed, said membrane comprising:
a membrane substrate constructed of a flexible elastic material and having a wall presenting a wall surface exposed to wastewater in service of the membrane;
a biocide dispersed throughout said wall of the substrate; and
a halogen bonded to at least said wall surface of the substrate in a manner to provide a barrier thereon effective to resist migration of the biocide out of said wall through said wall surface.

6. A diffuser as set forth in claim 5, wherein said halogen comprises fluorine.

7. A diffuser as set forth in claim 6, wherein said fluorine is applied to said substrate in gaseous form under vacuum conditions.

8. A diffuser as set forth in claim 6, wherein:
said wall has a plurality of perforations which open and close in response to air pressure to said membrane to respectively apply aeration and block aeration of the wastewater, said perforations each having edges; and
said edges are devoid of said halogen.

9. A diffuser as set forth in claim 8, wherein:
said wall has a plurality of perforations which open and close in response to air pressure to said membrane to respectively apply aeration and block aeration of the wastewater, said perforations each having edges; and
said halogen is bonded to said edges.

10. A process for aerating wastewater, comprising:
constructing a flexible membrane having a selected shape and a wall having an outside surface;
dispersing a biocide throughout said wall of the membrane;
applying a halogen gas to said membrane in a manner to bond the halogen to at least said outside surface of said wall to provide a barrier resisting migration of the biocide out of said wall through said outside surface thereof;
applying said membrane to a diffuser body to seat thereon, said membrane having a plurality of normally closed perforations which are closed when the membrane is seated on the diffuser body, but which open when air is applied through the diffuser body to expand said membrane;
immersing said diffuser body and membrane in wastewater; and
applying air to said diffuser body to expand said membrane, thereby aerating the wastewater through said perforations.

11. A process as set forth in claim 10, wherein said halogen comprises fluorine.

12. A process as set forth in claim 10, wherein:
said perforations have edges; and
said edges are devoid of halogen.

13. A method of constructing a flexible diffuser membrane used on a diffuser body to aerate wastewater, comprising:
providing a membrane substrate constructed of a flexible elastic material and having a wall surface;
applying a halogen to said wall surface to effect cleaning of contaminants therein;
securing to said wall surface a coating selected from the group consisting of PTFE and polyurethane; and
heating said substrate with the coating thereon to a temperature of at least approximately 350° F. to effect bonding of the coating to said wall surface.
